(19) United States
(12) Patent Application Publication
(10) Pub. No.: US 2019/0092073 A1
(43) Pub. Date: Mar. 28, 2019

(54) DEVICE FOR ATTACHING A WRITING UTENSIL TO A NOTEBOOK

(71) Applicant: Rocket Innovations, Inc., Melrose, MA (US)

(72) Inventors: Jacob Epstein, Wakefield, MA (US); Joseph Lemay, Melrose, MA (US); Steven Chen, Boston, MA (US); Lukas Scheurer, Providence, RI (US)

(21) Appl. No.: 16/138,395

(22) Filed: Sep. 21, 2018

Related U.S. Application Data
(60) Provisional application No. 62/561,960, filed on Sep. 22, 2017.

(51) Int. Cl. B42D 3/12; B42D 3/18; B43K 23/00

(52) U.S. Cl. CPC B42D 3/12; B42F 13/406; B43K 23/00; B42D 3/18

(57) ABSTRACT

A writing utensil holder for attachment to a notebook includes a plate having a notebook attachment portion and a writing utensil holding portion. The notebook attachment portion is configured to attach to a notebook such that the notebook attachment portion is inside of a perimeter of the notebook when the notebook attachment portion is attached to the notebook and the holding portion is outside of the notebook perimeter when the notebook attachment portion is attached to the notebook. The writing utensil holder also includes a securing implement secured to the holding portion and configured to hold a writing utensil between the securing instrument and the holding portion such that the writing utensil is outside of the notebook perimeter.

### CROSS-REFERENCE TO RELATED APPLICATION(S)

This patent application claims the benefit of U.S. Provisional Patent Application No. 62/561,960 entitled Device for Attaching a Writing Utensil to a Notebook filed on Sep. 22, 2017, which is hereby incorporated herein by reference in its entirety.

### STATEMENT REGARDING PRIOR DISCLOSURES BY THE INVENTOR OR A JOINT INVENTOR UNDER 37 C.F.R. 1.77(b)(6)

Aspects of the present invention were disclosed by way of a Kickstarter campaign named “Pen Station” begun on Oct. 18, 2017, which can be accessed at https://www.kickstarter.com/projects/penstation/penstation. Applicant notes that the date of this disclosure is after the priority date of this patent application, i.e., after the filing date of the above-referenced provisional patent application. However, out of an abundance of caution, pursuant to the guidance of 78 Fed. Reg. 11076 (Feb. 14, 2013), Applicant is identifying this disclosure in the specification in lieu of filing a declaration under 37 C.F.R. 1.130(a). Applicant believes that such disclosure is subject to the exceptions of 35 U.S.C. 102(b)(1)(A) or 35 U.S.C. 102(b)(2)(a) as having been made or having originated from one or more members of the inventive entity of the application under examination.

### FIELD OF THE INVENTION

The invention generally relates to devices for holding a writing utensil and, more particularly, the invention relates to devices that attach a writing utensil to a notebook.

### BACKGROUND OF THE INVENTION

Paper notebooks and ink writing utensils continue to be valuable tools in education, the workplace, art, and everyday life. There are thousands of choices for notebooks and thousands of choices of writing utensils. Many people find a preference for a specific notebook and/or a specific writing utensil.

Most people carry their notebook and writing utensils in backpacks, pocketbooks, or otherwise general purpose bags. This can lead to writing utensils getting separated from the notebook or even lost. Thus, people may have to shuffle through a bag to find a writing utensil or a specific writing utensil they prefer to use. In the case of notebooks which require a specific writing utensil, this can prevent note taking all together.

### SUMMARY OF VARIOUS EMBODIMENTS

In accordance with one embodiment of the invention, a system includes a notebook having a binding configured to hold a plurality of pages. The notebook has at least one cover that defines a notebook perimeter. The system also has a writing utensil holder that has a substantially planar surface. The writing utensil holder also has an elastic loop configured to hold a writing utensil between the elastic loop and the substantially planar surface. The writing utensil holder also has a notebook attachment portion configured to attach to a cover of the notebook. The writing utensil holder is configured to hold the writing utensil outside of the notebook perimeter when the notebook attachment portion is attached to the cover of the notebook.

In accordance with another embodiment of the invention, a device for holding a writing utensil includes a plate configured to attach to a notebook. The notebook defines a notebook perimeter. The plate has a notebook attachment portion configured to overlap with the notebook perimeter when the notebook attachment portion is attached to the notebook. The plate further includes a writing utensil portion configured to hold, in conjunction with a constraining implement, a writing utensil therebetween. The device is further configured so that the writing utensil portion is outside of the notebook perimeter when the notebook attachment portion is attached to the notebook.

Among other things, the constraining implement may be an elastic loop. The elastic loop may be a complete loop or a portion of the loop. To that end, the plate may have holes through which to loop the elastic loop. Alternatively, the elastic loop may be bonded to the plate.

The plate may have a notebook attachment portion that includes an adhesive configured to attach to a portion of the notebook. The plate may be thin, for example, having a thickness of less than 2 mm. Illustrative embodiments of the plate may have a thickness in the range of between about 0.3 mm and 2.0 mm. In some embodiments, the plate may be about 0.5 mm thick. Additionally, or alternatively, the plate may include slanted edges.

In accordance with another embodiment, a notebook includes a binding configured to hold a plurality of pages. The notebook has at least one cover that defines a notebook perimeter. A writing utensil holding portion extends from the cover, and the writing utensil holder is configured to hold a writing utensil outside of the notebook perimeter.

The writing utensil holding portion may include a substantially planar surface and at least a portion of an elastic loop. The writing utensil may be held between the substantially planar surface and the at least a portion of an elastic loop. To that end, the substantially planar surface may be smooth.

In accordance with another embodiment, a system comprises a notebook having a binding configured to hold a plurality of pages and a cover defining a notebook perimeter, and further comprises a writing utensil holder having a notebook attachment portion and a holding portion, the notebook attachment portion configured to attach to the notebook such that the notebook attachment portion is inside of the notebook perimeter when the notebook attachment portion is attached to the notebook and the holding portion is outside of the notebook perimeter when the notebook attachment portion is attached to the notebook, the writing utensil holder also having a securing implement secured to the holding portion and configured to hold a writing utensil between the securing instrument and the holding portion such that the writing utensil is outside of the notebook perimeter.

In various alternative embodiments, the securing implement may include an elastic loop. The holding portion may have holes through which the elastic loop is secured. The elastic loop may be bonded to the holding portion. Alternatively, the securing implement may include a clip. In any case, the notebook attachment portion may include an adhesive configured to attach to a portion of the notebook. The plate may be between around 0.3 mm and 2.0 mm thick, e.g., around 0.5 mm thick. The holding portion may have slanted edges and/or rounded corners.

In accordance with another embodiment, a device for holding a writing utensil comprises a plate having a notebook attachment portion and a holding portion, the notebook attachment portion configured to attach to a notebook such that the notebook attachment portion is inside of a perimeter of the notebook when the notebook attachment portion is attached to the notebook and the holding portion is outside of the notebook perimeter when the notebook attachment portion is attached to the notebook. The device also comprises a securing implement secured to the holding portion and configured to hold a writing utensil between the securing instrument and the holding portion such that the writing utensil is outside of the notebook perimeter.

In various alternative embodiments, the securing implement may include an elastic loop. The holding portion may have holes through which the elastic loop is secured. The elastic loop may be bonded to the holding portion. Alternatively, the securing implement may include a clip. In any case, the notebook attachment portion may include an adhesive configured to attach to a portion of the notebook. The plate may be between around 0.3 mm and 2.0 mm thick, e.g., around 0.5 mm thick. The holding portion may have slanted edges and/or rounded corners.

In accordance with another embodiment, a notebook having a notebook perimeter comprises a binding configured to hold a plurality of pages, a cover, a writing utensil holding portion extending from the cover outside of the notebook perimeter, and a securing implement secured to the writing utensil holding portion and configured to hold a writing utensil between the securing instrument and the holding portion such that the writing utensil is outside of the notebook perimeter.

In various alternative embodiments, the securing implement may include an elastic loop. The holding portion may have holes through which the elastic loop is secured. The elastic loop may be bonded to the holding portion. Alternatively, the securing implement may include a clip. In any case, the notebook attachment portion may include an adhesive configured to attach to a portion of the notebook. The plate may be between around 0.3 mm and 2.0 mm thick, e.g., around 0.5 mm thick. The holding portion may have slanted edges and/or rounded corners. The writing utensil holding portion may be integral with the cover or may be attached to the cover.

In accordance with another embodiment, a system comprises an apparatus having a writing surface and also defining a perimeter and a writing utensil holder having an apparatus attachment portion and a writing utensil holding portion, the writing utensil holding portion having a writing utensil securing implement secured thereto, the apparatus attachment portion configured to attach to the apparatus so that the apparatus attachment portion is within the perimeter when the apparatus attachment portion is attached to the apparatus, and the writing utensil securing implement is outside of the perimeter when the apparatus attachment portion is attached to the apparatus.

In accordance with another embodiment, a writing utensil holder comprises a substrate and a writing utensil securing implement, the substrate and the writing utensil securing implement configured to hold a writing utensil between them.

In various alternative embodiments, the writing utensil holder may further comprise an apparatus attachment portion configured to attach the writing utensil holder to an apparatus defining a perimeter. The writing utensil holder may be configured such that the writing utensil securing implement is outside of the perimeter when the apparatus attachment portion is attached to the apparatus.

In accordance with another embodiment, a writing utensil holder comprises a substrate, a writing utensil securing implement configured to hold a writing utensil, and an apparatus attachment portion configured to attach the writing utensil holder to an apparatus defining a perimeter and having a writing surface, wherein the writing utensil holder is configured such that the writing utensil securing implement is outside of the perimeter when the apparatus attachment portion is attached to the apparatus.

Additional embodiments may be disclosed and claimed.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a front view of a writing utensil holder in accordance with illustrative embodiments of the invention.

FIG. 2 schematically shows a rear view of a writing utensil holder in accordance with illustrative embodiments of the invention.

FIG. 3 schematically shows a side view of a writing utensil holder in accordance with illustrative embodiments of the invention.

FIG. 4 schematically shows a front view of a writing utensil holder applied to a notebook in accordance with illustrative embodiments of the invention.

FIG. 5 schematically shows a rear view of the writing utensil holder applied to a notebook in accordance with illustrative embodiments of the invention.

FIG. 6 schematically shows a side view of the writing utensil holder applied to a notebook with a writing utensil in accordance with illustrative embodiments of the invention.

FIG. 7 schematically shows a side view of the writing utensil holder applied to a notebook with two writing utensils in accordance with illustrative embodiments of the invention.

FIG. 8 schematically shows a top/side view of the writing utensil holder with a single writing utensil in accordance with illustrative embodiments of the invention.

FIG. 9 schematically shows a top/side view of a prior art writing utensil holder that has a single entire loop.

FIG. 10 schematically shows the writing utensil holder coming into contact with an object in accordance with illustrative embodiments of the invention.

FIG. 11 schematically shows the two ends of the elastic loop joined together to form a complete loop, in accordance with one exemplary embodiment.

FIG. 12 schematically shows the two ends of the elastic loop overlapping and joined together to form a complete loop, in accordance with one exemplary embodiment.

FIG. 13 schematically shows the two ends of the elastic loop secured to the top of the writing utensil holder, in accordance with one exemplary embodiment.

FIG. 14 schematically shows the two ends of the elastic loop secured to the bottom of the writing utensil holder, in accordance with one exemplary embodiment.

FIG. 15 is a schematic diagram showing a notebook cover having an integral holding portion, in accordance with one exemplary embodiment.

It should be noted that the foregoing figures and the elements depicted therein are not necessarily drawn to consistent scale or to any scale. Unless the context otherwise suggests, like elements are indicated by like numerals.

### DESCRIPTION OF ILLUSTRATIVE EMBODIMENTS

In illustrative embodiments, a writing utensil holder includes a thin plate with a notebook attachment portion (e.g., adhesive portion) and a writing utensil attachment portion (e.g., sometimes referred to herein as a holding portion or pen holder). The writing utensil attachment portion may include one or more securing implements such as one or more clips or elastic loops through which a writing utensil may be positioned. The writing utensil holder is configured so that the notebook attachment portion has a low profile and attaches to a part of the notebook (e.g., the back cover) without noticeably affecting the writing surfaces of the notebook. The writing utensil attachment portion preferably does not come to lie underneath the pages of the notebook when the notebook attachment portion is attached to the notebook. Thus, the writing utensil holder may attach to the notebook without raising/bulging portions of the pages of the notebook when a user writes on them.

Illustrative embodiments semi-permanently (e.g., attached by the user via use of adhesive), or permanently (e.g., sold as part of the notebook and bonded to or formed integrally with the notebook), attach the writing utensil holder to the notebook. Thus, the notebook and writing utensil are reliably held together in bags, on desks, or wherever the user may take them.

FIG. 1 schematically shows a front view of a writing utensil holder 1 in accordance with illustrative embodiments of the invention. In some embodiments, the writing utensil holder 1 may also be referred to as a pen holder 1. As shown in FIG. 1, the writing utensil holder 1 may include a thin plate 3 with a holding portion 7 and a notebook attachment portion 8 (e.g., with mounting adhesive 2). The notebook attachment portion 8 may have a shallow cavity to allow for recessed placement of the mounting adhesive 2, such as a two-sided foam tape with one side that adheres to the plate 3 and the other side that adheres to a notebook or other surface. The holding portion 7 may include a securing implement such as, for example, a writing utensil clip or an elastic band or loop 4 (referred to herein for convenience as a loop). The elastic loop 4 may be secured to the holding portion 7 of the writing utensil holder 1, e.g., the elastic loop 4 may be looped through the plate 3 through two elongated holes 6, or the elastic loop 4, or a portion thereof, may be attached directly to the plate 3 (e.g., half of a loop 4 may be bonded to the plate 3). As discussed in more detail below, the configuration of the plate 3 with elastic loop 4 allows for low friction insertion and removal of common writing utensils of various sizes (e.g., pens, markers, highlighters, pencils, mechanical pencils, etc.). Also as discussed in more detail below, the writing utensil holder 1 can be mounted to a notebook or other surface by placing the notebook attachment portion 8 with mounting adhesive 2 in contact with the surface. The writing utensil holder 1 is specifically configured so that the writing utensil holder 1 can be mounted to the surface with the holding portion 7 extending beyond an edge of the surface (e.g., outside of the perimeter of the writing surface) so as to allow unencumbered insertion, removal, and overall access to a writing utensil.

In illustrative embodiments, the writing utensil holder 1 is configured to prevent and/or mitigate accidental dislodgement from the notebook. To that end, the holding portion 7 of the thin plate 3 may have angled edges 12 and rounded corners 5. The angled edges 12 and rounded corners 5 help mitigate accidental dislodgement of the writing utensil holder 1 from the notebook. For example, if the angled edge 12 contacts an object, the object may slide along the edge 12 and past the rounder corner 5, rather than pressing against the holder 1 until one or the other gives way. Thus, the angled edges 12 and rounded corners 5 deflect objects that the plate is pushed against that may otherwise create a jarring force where it is mounted.

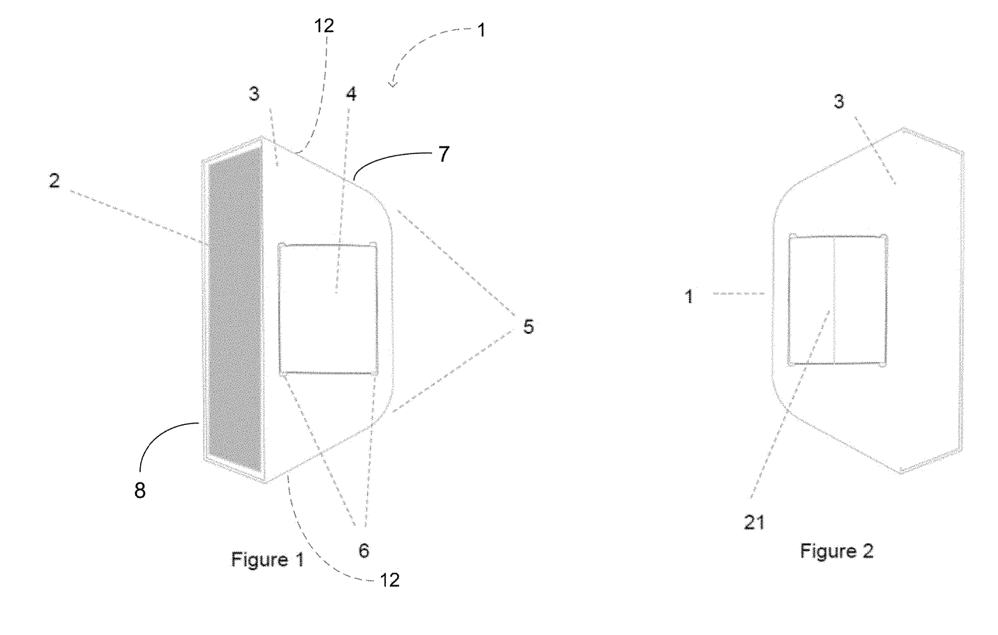

FIG. 2 schematically shows a rear view of the writing utensil holder 1 in accordance with illustrative embodiments of the invention. In illustrative embodiments, the rear of the writing utensil holder 1 is similar to the front of the writing utensil holder 1 except that it does not have a mounting adhesive 2. The elastic loop 4 may be bonded in the rear, for example, to simplify the manufacturing process. Bonding the elastic loop may be done by stitching, gluing, plastic welding or other bonding that creates a small, low profile seam 21.

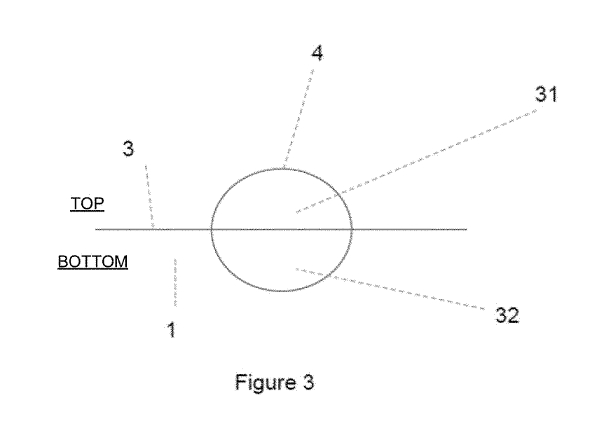

FIG. 3 schematically shows a top/side perspective view of the writing utensil holder 1 in accordance with an illustrative embodiment of the invention. As can be seen in FIG. 3, in this example, the elastic loop 4 can be stretched on one or both sides of the smooth plate 3, e.g., to form one or two semi-circle loop portions 31, 32. The writing utensil(s) may be positioned/inserted into the semi-circular loops 31 and/or 32. Accordingly, in some embodiments, the writing utensil holder 1 may hold a first writing utensil on the top and a second writing utensil on the bottom.

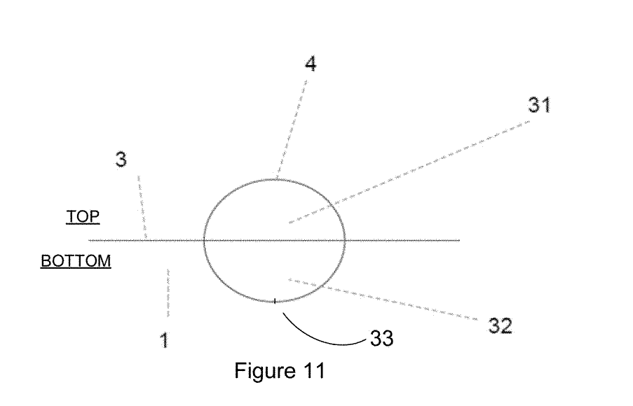

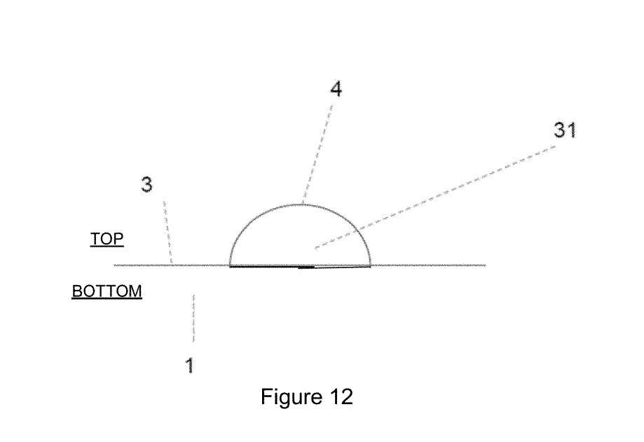

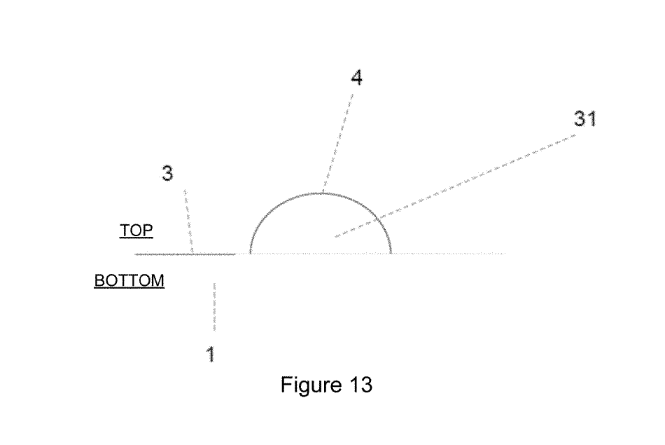

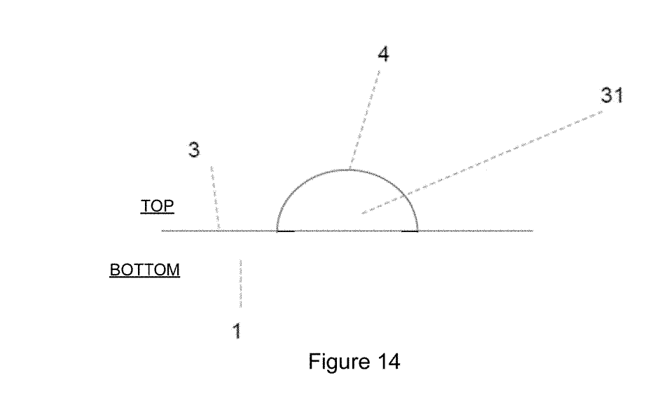

FIG. 11 schematically shows the two ends of the elastic loop 4 joined together to form a complete loop, in accordance with one exemplary embodiment. The two ends of the elastic loop 4 may be joined by any appropriate coupling, such as, for example, an adhesive, ultrasonic weld, staple, crimping tool, etc. The two ends may be joined directly, or the two end portions of the elastic loop 4 may overlap and then be joined, for example, as depicted in FIG. 12. In any case, the elastic loop 4 additionally may be secured to the bottom of the plate such as using an adhesive or other coupling mechanism. The elastic loop 4 may be secured to the writing utensil holder 1 in other ways, such as, for example, with the two ends of the elastic loop secured to the top of the writing utensil holder, as depicted in FIG. 13, or with the two ends of the elastic loop secured to the bottom of the writing utensil holder, as depicted in FIG. 14.

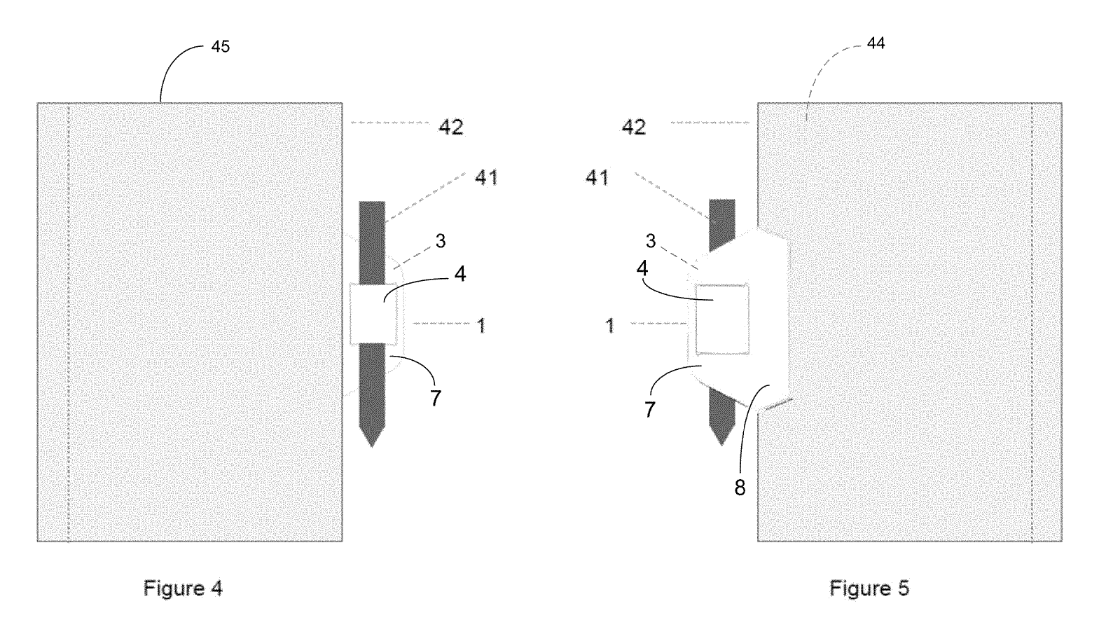

FIGS. 4-7 schematically show how the writing utensil holder 1 may be mounted to a standard notebook. FIG. 4 shows that the notebook 42 defines a notebook perimeter 45. As known by those of skill in the art, the notebook perimeter 45 may increase when the notebook 42 is opened, and may decrease when the notebook 42 is closed. FIGS. 4-5 show the notebook in a closed position. FIG. 5 schematically shows a rear view of the writing utensil holder 1 applied to a notebook 42 in accordance with illustrative embodiments of the invention. The mounting adhesive section 2 of the writing utensil holder 1 (visible in FIG. 1) is pushed against the back of the rear cover 44 of the notebook 42. This mounting position points the non-adhesive section of the writing utensil holder 1 (e.g., the top of the smooth plate 3) towards the top of the notebook 42. Thus, the rear of the writing utensil holder 1 faces the same direction as the rear of a standard notebook 42. In this example, the writing utensil holder 1 is positioned on the side of the notebook from which the notebook is opened, although the writing utensil holder 1 can be positioned elsewhere, e.g., along the top or bottom edge.

In illustrative embodiments, the plate 3 functions as a frame on which other components are mounted. The plate 3 may be smooth and/or thin and may be formed from plastic (e.g., HDPE, Poly or Nylon) and/or metal (e.g., aluminum) or any other durable, smooth, and/or thin material. The plate 3 may be thin, for example, having a thickness of less than 2 mm. Illustrative embodiments of the plate 3 may have a thickness in the range of between about 0.3 mm and 2.0 mm. In some embodiments, the plate 3 may be about 0.5 mm thick. In some embodiments, at least a portion of the plate 3 may be formed from the same material as the notebook 42 (e.g., the cover of the notebook 42). After the writing utensil holder 1 is mounted to the notebook 42, such as in FIG. 4 (which shows a front/top view of the notebook 42 with mounted writing utensil holder 1) and FIG. 5 (which shows a rear/bottom view of the notebook 42 with writing utensil holder 1 mounted to the rear cover 44), only the notebook attachment portion 8 of the smooth plate 3 and the adhesive 2 reside within the perimeter 45 of the notebook 42.

In other words, the rest of the writing utensil holder 1, including the holding portion 7 with elastic loop 4, is positioned outside of the perimeter 45 formed by the notebook 42. As a result, there is no perceptible slope, bump or distortion of the writing surface, so users of the notebook 42 can write normally without contours on/under the writing page. In some embodiments, positioning the elastic loop 4 outside of the perimeter 45 of the notebook 42 provides an advantage over prior art writing utensil holders that may stick an elastic loop (or other thick mechanism to attach a writing utensil) on the cover, inside the perimeter 45 formed by the notebook 42, thereby creating a distortion in the writing surface.

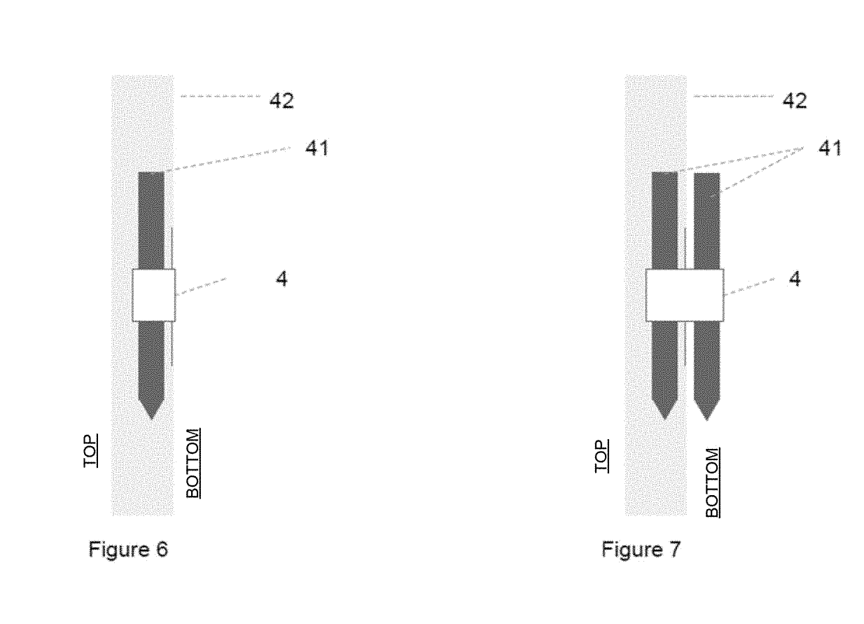

After mounting the writing utensil holder 1 to a standard notebook 42, a writing utensil 41 (or any other standard writing instrument such as a pen, pencil, mechanical pencil, marker, highlighter, etc.) may be inserted into the elastic loop 31 facing the top of the notebook . Inserting a writing utensil into the top loop 31 puts the writing utensil into the same plane as the plane of the notebook 42 pages, thereby not adding substantial thickness to the overall notebook 42 profile. This can be seen in FIG. 6. It should be noted that a writing utensil holder 1 can be configured to hold more than one writing utensil on the top side of the holding portion 7, e.g., side-by-side using multiple elastic loops.

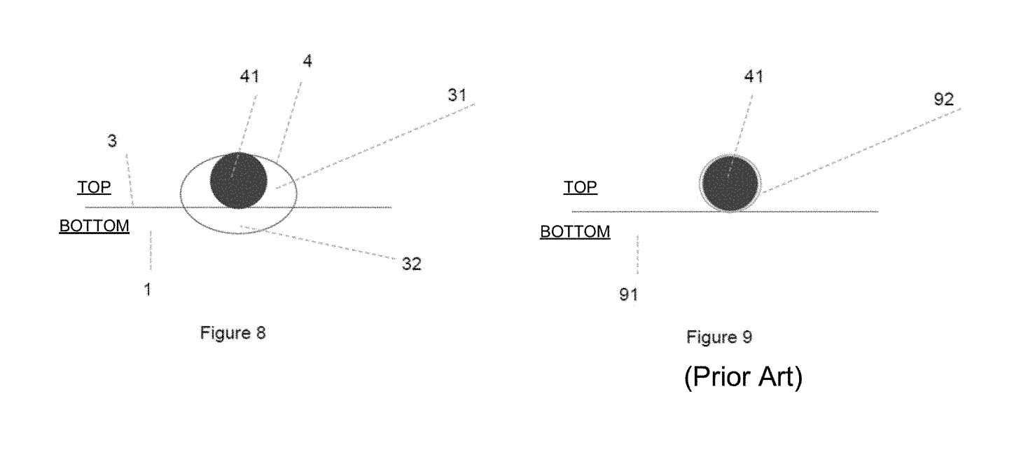

FIG. 8 schematically shows a top/side view of the writing utensil holder 1 with a single writing utensil 41 in accordance with illustrative embodiments of the invention. Users may position the writing utensil 41 in the writing utensil holder 1 by sliding the writing utensil 41 against the smooth plate 3 and through the elastic loop 4, for example, in the top semicircle 31. Insertion into the writing utensil attachment portion 7 is configured to be easy for the user. Although one piece of the writing utensil 41 generates friction against the elastic loop 4, the rest of the writing utensil is either unobstructed or pressed against the plate 3, which generally has a smaller coefficient of friction than the elastic loop 4 material.

FIG. 9 schematically shows a top/side view of a prior art writing utensil holder that has a single entire loop, as known in the art. Writing utensil holders designed similar to those shown in FIG. 9, where the writing utensil is inserted into the entire elastic loop, have much more friction with the elastic loop, since the entire loop surface makes contact with the entire writing utensil surface. This makes inserting and extracting writing utensils difficult. Illustrative embodiments of the invention reduce friction to a portion of the writing utensil surface, thereby reducing the necessary insertion and extraction force.

As described above with reference to FIG. 1, the writing utensil holder 1 preferably also has angled edges and rounded corners 5. These curves serve a few purposes. First, angling down the smooth surface outside the profile of the notebook maximizes the surface area of the adhesive strip and minimizes the amount of smooth plate exposed to the user of the writing utensil holder. This makes the notebook easier to carry.

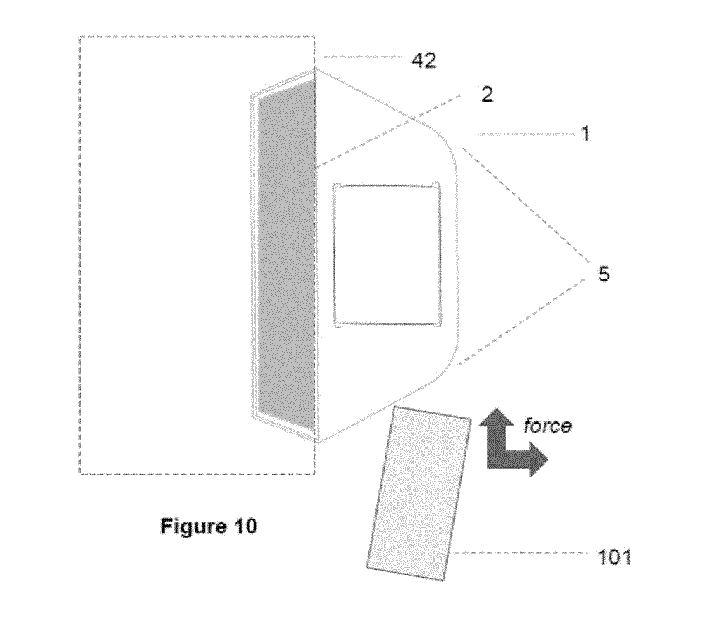

FIG. 10 schematically shows the writing utensil holder coming into contact with an object in accordance with illustrative embodiments of the invention. The angled edges and rounded corners 5 also provide resilience against bumping other objects by deflecting the object 101 away. For example, one inserts a notebook 42 with a writing utensil holder installed into a backpack or bag filled with other objects 101. A non-angled edge contacting another object would produce a large moment of force on the writing utensil holder causing it to want to twist and potentially cause catastrophic force (e.g., sufficient to cause the adhesive strip and/or part of the notebook to come apart or deform). Whereas, with the angled design 5 of the writing utensil holder 1 objects 101 coming into contact with the edges 5 deflect away, producing far less force on the adhesive strip. These angled edges represent a much better mounting profile of a writing utensil holder compared to other non-angled writing utensil holders which are attached to notebooks.

The writing utensil holder 1 may hold any common writing utensil that remotely resembles a standard writing utensil, pen, marker, etc. It can also be seen in FIG. 7 that, depending on the circumference of the writing utensil, the writing utensil holder 1 may be used to store two (or more) writing utensils. Thin writing utensils could allow a writing utensil placed in both semicircles 31, 32 of the elastic loop 4, with one writing utensil situated on the top side of the holding portion 7 and one writing utensil situated on the bottom side of the holding portion 7. Extremely thin writing utensils could potentially even have two on both sides. In some embodiments, the writing utensil holder design is limited by writing utensils which fall beyond the circumference of the entire stretched elastic loop 4.

The examples shown in FIGS. 4-7 and described in this document of writing utensils with standard notebooks are only to illustrate one common use case and demonstrate the advantages of the product. It can clearly be seen that the writing utensil holder may be attached to either side of a standard notebook or for that matter at the top or bottom of a standard notebook. It should also be noted that the writing utensil holder could be used in other applications such as holding a whiteboard marker to a whiteboard, holding a writing utensil or stylus to a tablet or laptop computer, or holding crayons to a coloring book. It is indeed a universal writing utensil holder for many applications. Thus, in the context of the claimed invention, the writing utensil holder may be attached to virtually any device having a writing surface or virtually any device that is used with a writing utensil, including, but not limited to, a standard notebook (e.g., a spiral-bound notebook, a composition book, a heat- or moisture-erasable notebook, a journal, a diary, etc.), a binder (e.g., a three-ring binder, a portfolio, a clipboard, a folder, etc.), a tablet or laptop computer (e.g., having a touchscreen or other input device that can be manipulated using a stylus or other utensil), a coloring book or other artist pad, etc. Also, in the context of the claimed invention, a “writing utensil” may be virtually anything used to write on or in the above-mentioned devices or used along with the above-mentioned devices, including, but not limited to, a pen, pencil, mechanical pencil, marker, highlighter, stylus, laser pointer, etc. Writing utensils may be held onto the writing utensil holder in other ways, such as, for example, clipping onto the writing utensil holder plate or the securing implement. Writing utensil holders also may include other types of securing implements, such as, for example, a pocket into which a writing utensil can be placed or onto which a writing utensil can be clipped.

One skilled in the art will realize the embodiments described herein may be embodied in other specific forms without departing from the spirit or essential characteristics thereof. The foregoing embodiments are therefore to be considered in all respects illustrative rather than limiting of the embodiments described herein.

Although the description refers to an elastic loop 4, it should be understood that in some embodiments a complete loop 4 is not necessary. For example, an incomplete loop 4 (e.g., half a loop 4 or a quarter of a loop 4) may be attached to the plate 4 without passing through holes 6. Alternatively, the incomplete loop 4 may pass through the holes 6 and have thicker stopping portions that prevent dislodgement of the loop from the holes 6. Additionally, or alternatively, instead of an elastic loop 4, the utensil holder 1 may have a clip for a writing utensil.

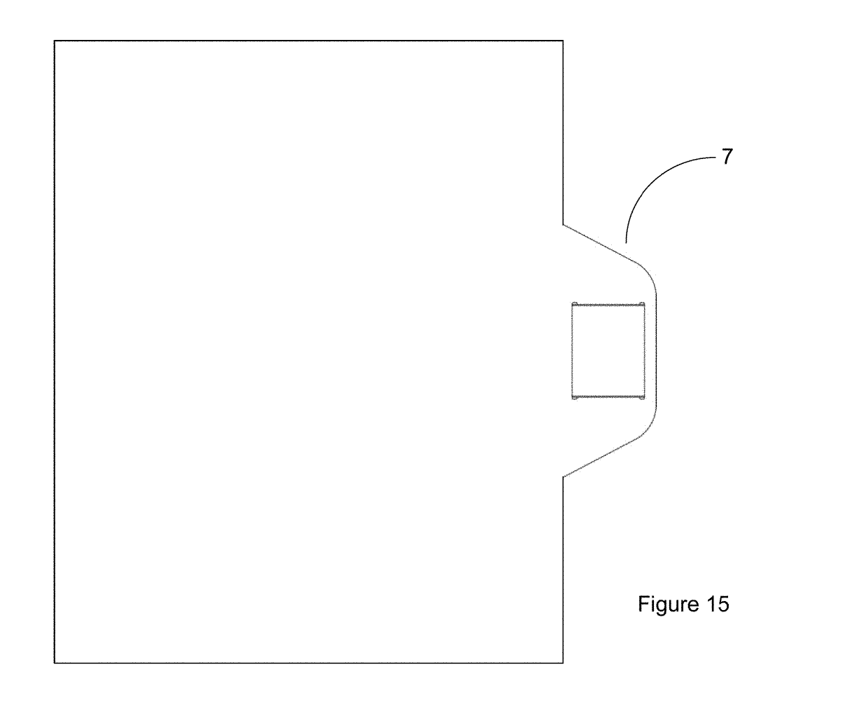

Furthermore, although some embodiments describe a notebook attachment portion 8, it should be understood that the writing utensil holder 1 may come attached to the notebook. Additionally, in some embodiments, the writing utensil holder 1 and the notebook may be manufactured as a unitary piece (although the loop 4 may still be a separate piece). For example, the notebook attachment portion 8 may be a part of the notebook, or the holding portion 7 may be a part of the notebook without a separate or distinct notebook attachment portion 8. FIG. 15 is a schematic diagram showing a notebook cover having an integral holding portion 7, in accordance with one exemplary embodiment.

Illustrative embodiments of the present invention provide several advantages. For example, illustrative embodiments attach to a notebook in such a way that changes in the writing surfaces of the notebook are undetectable. Another advantage is that illustrative embodiments fit a multitude of writing utensil types, shapes and sizes. Further, in some embodiments, writing utensils may be removed and inserted into the writing utensil holder without requiring large pushing or pulling forces. Illustrative embodiments have a further advantage in that they may be applied to virtually any notebook. Furthermore, the writing utensil holder may be shaped with curves to be both non-jarring aesthetically as well impact deflective when inserting and extracting from bags or backpacks filled with other items.

Various embodiments of the present invention may be characterized by the potential claims listed in the paragraphs following this paragraph (and before the actual claims provided at the end of the application). These potential claims form a part of the written description of the application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

Without limitation, potential subject matter that may be claimed (prefaced with the letter “P” so as to avoid confusion with the actual claims presented below) includes:

P1. A system comprising a notebook having a binding configured to hold a plurality of pages, the notebook having at least one cover defining a notebook perimeter; and a writing utensil holder having a substantially planar surface and an elastic loop configured to hold a writing utensil therebetween, the writing utensil holder further having a notebook attachment portion configured to attach to a cover of the notebook, the writing utensil holder configured to hold the writing utensil outside of the notebook perimeter when the notebook attachment portion is attached to the cover of the notebook.

P2. A device for holding a writing utensil, the device comprising a plate configured to attach to a notebook, the notebook defining a notebook perimeter; the plate having a notebook attachment portion configured to overlap with the notebook perimeter when the notebook attachment portion is attached to the notebook, the plate further having a writing utensil portion configured to hold, in conjunction with a constraining implement, a writing utensil therebetween; the device further configured so that the writing utensil portion is outside of the notebook perimeter when the notebook attachment portion is attached to the notebook.

P3. The device as defined by claim P2, wherein the constraining implement is a complete elastic loop.

P4. The device as defined by claim P3, wherein the plate has holes through which to loop the elastic loop.

P5. The device as defined by claim P2, wherein the constraining implement is a portion of an elastic loop.

P6. The device as defined by claim P5, wherein the elastic loop is bonded to the plate.

P7. The device as defined by claim P2, wherein the notebook attachment portion comprises an adhesive configured to attach to a portion of the notebook.

P8. The device as defined by claim P2, wherein the plate is less than 2 mm thick.

P9. The device as defined by claim P2 wherein the plate has slanted edges.

P10. A notebook comprising a binding configured to hold a plurality of pages; at least one cover defining a notebook perimeter; and a writing utensil holding portion extending from the cover, the writing utensil holder configured to hold a writing utensil outside of the notebook perimeter.

P11. The notebook as defined by claim P10, wherein the writing utensil holding portion comprises a substantially planar surface and at least a portion of an elastic loop , the writing utensil being held between the substantially planar surface and the at least a portion of an elastic loop.

P12. The notebook as defined by claim P11, wherein the substantially planar surface is smooth.

P13. The notebook as defined by claim P11, wherein the thickness of the substantially planar surface is in the range of about 0.3 mm and about 2.0 mm.

P14. The notebook as defined by claim P11, wherein the thickness of the substantially planar surface is about 0.5 mm.

Although the above discussion discloses various exemplary embodiments of the invention, it should be apparent that those skilled in the art can make various modifications that will achieve some of the advantages of the invention without departing from the true scope of the invention. Any references to the “invention” are intended to refer to exemplary embodiments of the invention and should not be construed to refer to all embodiments of the invention unless the context otherwise requires. The described embodiments are to be considered in all respects only as illustrative and not restrictive.

What is claimed is:

1. A writing utensil holder comprising:
a plate having a notebook attachment portion and a writing utensil holding portion, the notebook attachment portion configured to attach to a notebook such that the notebook attachment portion is inside of a perimeter of the notebook when the notebook attachment portion is attached to the notebook and the holding portion is outside of the notebook perimeter when the notebook attachment portion is attached to the notebook; and
a securing implement secured to the holding portion and configured to hold a writing utensil between the securing instrument and the holding portion such that the writing utensil is outside of the notebook perimeter.

2. The writing utensil holder as defined by claim 1, wherein the securing implement comprises an elastic loop.

3. The writing utensil holder as defined by claim 2, wherein the holding portion has holes through which the elastic loop is secured.

4. The writing utensil holder as defined by claim 2, wherein the elastic loop is bonded to the holding portion.

5. The writing utensil holder as defined by claim 1, wherein the securing implement comprises a clip.

6. The writing utensil holder as defined by claim 1, wherein the notebook attachment portion comprises an adhesive configured to attach to a portion of the notebook.

7. The writing utensil holder as defined by claim 1, wherein the plate is between around 0.3 mm and 2.0 mm thick.

8. The writing utensil holder as defined by claim 1, wherein the holding portion has at least one of (a) slanted edges or (b) rounded corners.

9. A system comprising:
a notebook having a binding configured to hold a plurality of pages and a cover defining a notebook perimeter; and
a writing utensil holder having a notebook attachment portion and a writing utensil holding portion, the notebook attachment portion configured to attach to the notebook such that the notebook attachment portion is inside of the notebook perimeter when the notebook attachment portion is attached to the notebook and the holding portion is outside of the notebook perimeter when the notebook attachment portion is attached to the notebook, the writing utensil holder also having a securing implement secured to the holding portion and configured to hold a writing utensil between the securing instrument and the holding portion such that the writing utensil is outside of the notebook perimeter.

10. The system as defined by claim 9, wherein the securing implement comprises an elastic loop.

11. The system as defined by claim 10, wherein the holding portion has holes through which the elastic loop is secured.

12. The system as defined by claim 10, wherein the elastic loop is bonded to the holding portion.

13. The system as defined by claim 9, wherein the securing implement comprises a clip.

14. The system as defined by claim 9, wherein the notebook attachment portion comprises an adhesive configured to attach to a portion of the notebook.

15. The system as defined by claim 9, wherein the plate is between around 0.3 mm and 2.0 mm thick.

16. The system as defined by claim 9, wherein the holding portion has at least one of (a) slanted edges or (b) rounded corners.

17. A notebook having a notebook perimeter, the notebook comprising:
a cover;
a writing utensil holding portion extending from the cover outside of the notebook perimeter; and
a securing implement secured to the writing utensil holding portion and configured to hold a writing utensil between the securing instrument and the holding portion such that the writing utensil is outside of the notebook perimeter.

18. The notebook as defined by claim 17, wherein the securing implement comprises an elastic loop.

19. The notebook as defined by claim 18, wherein the holding portion has holes through which the elastic loop is secured.

20. The notebook as defined by claim 18, wherein the elastic loop is bonded to the holding portion.

21. The notebook as defined by claim 17, wherein the securing implement comprises a clip.

22. The notebook as defined by claim 17, wherein the notebook attachment portion comprises an adhesive configured to attach to a portion of the notebook.

23. The notebook as defined by claim 17, wherein the plate is between around 0.3 mm and 2.0 mm thick.

24. The notebook as defined by claim 17, wherein the holding portion has at least one of (a) slanted edges or (b) rounded corners.

25. The notebook as defined by claim 17, wherein the writing utensil holding portion is integral with the cover.

26. The notebook as defined by claim 17, wherein the writing utensil holding portion is attached to the cover.

27. A system comprising:
an apparatus having a writing surface, the apparatus defining a perimeter; and
a writing utensil holder having an apparatus attachment portion and a writing utensil holding portion, the writing utensil holding portion having a writing utensil securing implement secured thereto;
the apparatus attachment portion configured to attach to the apparatus so that:
the apparatus attachment portion is within the perimeter when the apparatus attachment portion is attached to the apparatus; and
the writing utensil securing implement is outside of the perimeter when the apparatus attachment portion is attached to the apparatus.

28. A writing utensil holder comprising:
a substrate; and
a writing utensil securing implement, the substrate and the writing utensil securing implement configured to hold a writing utensil between them.

29. The writing utensil holder as defined by claim 28, further comprising an apparatus attachment portion configured to attach the writing utensil holder to an apparatus defining a perimeter.

30. The writing utensil holder as defined by claim 29, wherein the writing utensil holder is configured such that the writing utensil securing implement is outside of the perimeter when the apparatus attachment portion is attached to the apparatus.

31. A writing utensil holder comprising:
a substrate;
a writing utensil securing implement configured to hold a writing utensil; and
an apparatus attachment portion configured to attach the writing utensil holder to an apparatus defining a perimeter and having a writing surface;
wherein the writing utensil holder is configured such that the writing utensil securing implement is outside of the perimeter when the apparatus attachment portion is attached to the apparatus.
